(19) United States
(12) Patent Application Publication
(10) Pub. No.: US 2022/0362589 A1
(43) Pub. Date: Nov. 17, 2022

(54) Face Mask Assembly

(71) Applicant: Helen McMillan-Siah, Palmdale, CA (US)

(72) Inventor: Helen McMillan-Siah, Palmdale, CA (US)

(21) Appl. No.: 17/319,464

(22) Filed: May 13, 2021

(51) Int. Cl. A62B 18/08; A41D 13/11; A62B 23/02; A62B 7/10

(52) U.S. Cl. CPC A62B 18/086; A41D 13/1115; A41D 13/1161; A62B 18/084; A62B 23/025; A62B 7/10

(57) ABSTRACT

A face mask assembly includes a face mask is comprised of a particulate filtering material to filter air being breathed by a user. The face mask has a mouth opening extending through the face mask to expose the user's mouth when the face mask is worn to facilitate eating and drinking. A flap is movably coupled to the face mask and the flap is positionable in a closed position having the flap covering the mouth opening to filter air breathed by the user. The flap is positionable in an open position to facilitate the user to eat or drink. A first mating member is coupled to flap and a second mating member is coupled to the face mask. The first mating member is releasably mated to the first mating member when the flap is in the closed position for retaining the flap in the closed position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to face mask devices and more particularly pertains to a new face mask device for facilitating a user to eat or drink while wearing a face mask. The device includes a mouth opening extending through the face mask and a flap that can either cover or expose the mouth opening. Additionally, the device includes a first mating member on the flap and a second mating member on the face mask for retaining the flap in a closed position over the mouth opening.

### (2) Description of Related Art Including Information Disclosed Under 37 CFR 1.97 and 1.98

The prior art relates to face mask devices including a face mask which has a tube integrated into the face mask through which a user can inhale. The prior art discloses a variety of face masks which each has a mouth opening integrated into the face mask and a flap that covers the mouth opening. In no instance does the prior art disclose a face mask that has a mouth opening, a flap the covers the mouth opening and a pair of mating members for securing the flap in a closed position.

### BRIEF SUMMARY OF THE INVENTION

An embodiment of the disclosure meets the needs presented above by generally comprising a face mask is comprised of a particulate filtering material to filter air being breathed by a user. The face mask has a mouth opening extending through the face mask to expose the user's mouth when the face mask is worn to facilitate eating and drinking. A flap is movably coupled to the face mask and the flap is positionable in a closed position having the flap covering the mouth opening to filter air breathed by the user. The flap is positionable in an open position to facilitate the user to eat or drink. A first mating member is coupled to flap and a second mating member is coupled to the face mask. The first mating member is releasably mated to the first mating member when the flap is in the closed position for retaining the flap in the closed position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a face mask assembly according to an embodiment of the disclosure showing a flap in a closed position.

FIG. 2 is a front perspective view of an embodiment of the disclosure showing a flap in an open position.

FIG. 3 is a front phantom view of an embodiment of the disclosure.

FIG. 4 is a back view of an embodiment of the disclosure.

FIG. 5 is a left side view of an embodiment of the disclosure.

FIG. 6 is a perspective in-use view of an embodiment of the disclosure.

### DETAILED DESCRIPTION OF THE INVENTION

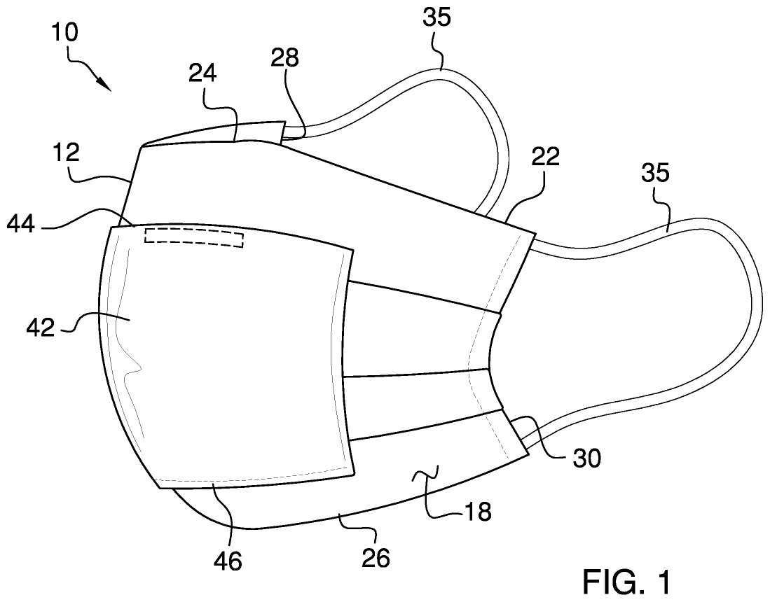

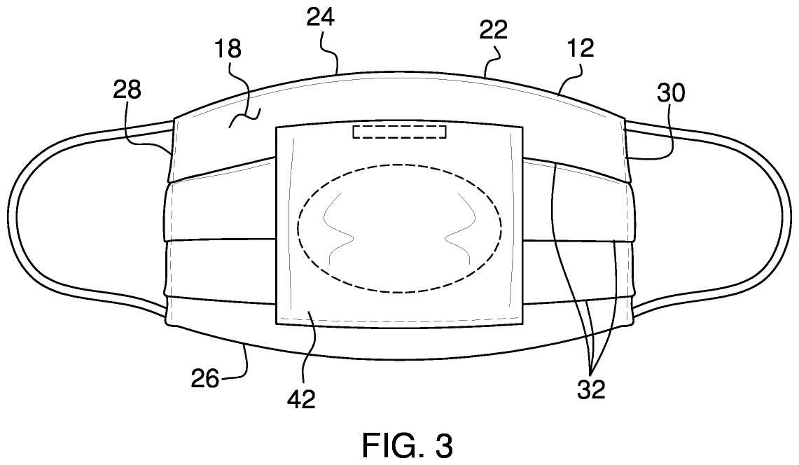

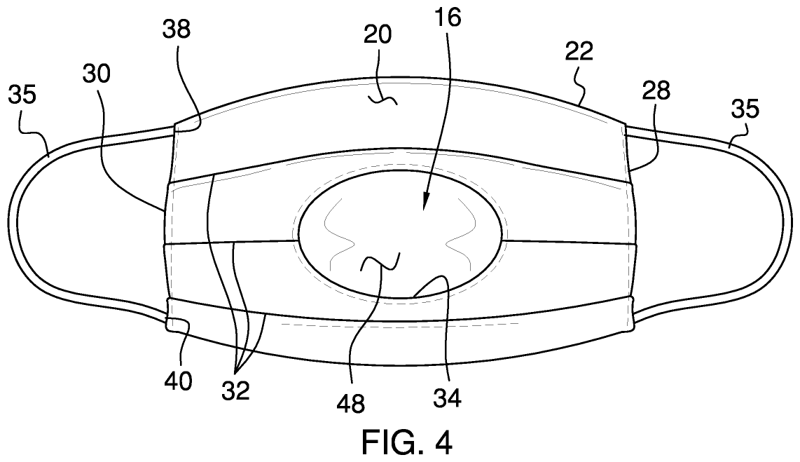

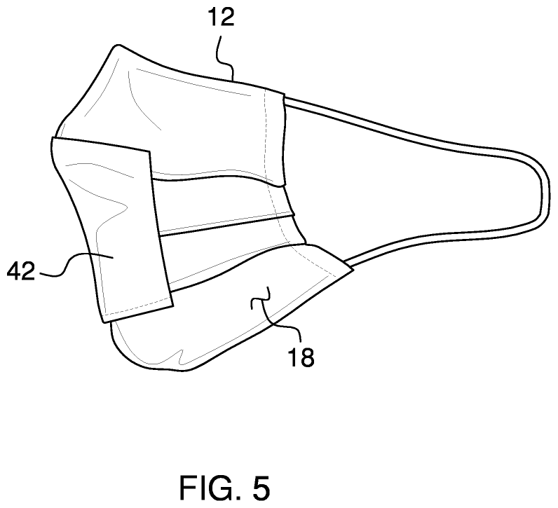

With reference now to the drawings, and in particular to FIGS. 1 through 6 thereof, a new face mask device embodying the principles and concepts of an embodiment of the disclosure and generally designated by the reference numeral 10 will be described.

As best illustrated in FIGS. 1 through 6, the face mask assembly 10 generally comprises a face mask 12 that is comprised of a particulate filtering material to filter air that is breathed by a user 14 when the user 14 is wearing the face mask 12. The particulate filtering material may be any material that is approved by the Center for Disease Control for inhibiting the airborne transmission of infectious diseases. The face mask 12 has a mouth opening 16 extending through the face mask 12 and the mouth opening 16 exposes the user's mouth 14 when the face mask 12 is worn to facilitate eating and drinking.

The face mask 12 has a front surface 18, a back surface 20 and a perimeter edge 22 extending between the front surface 18 and the back surface 20, and the perimeter edge 22 has a top side 24, a bottom side 26, a first lateral side 28 and a second lateral side 30. The face mask 12 has a plurality of pleats 32 integrated into the face mask 12 and each of the pleats 32 extends between the first lateral side 28 and the second lateral side 30. Moreover, the pleats 32 are spaced apart from each other and are distributed between the top side 24 and the bottom side 26. In this way the face mask 12 has an adjustable height to accommodate a variety of sizes of users.

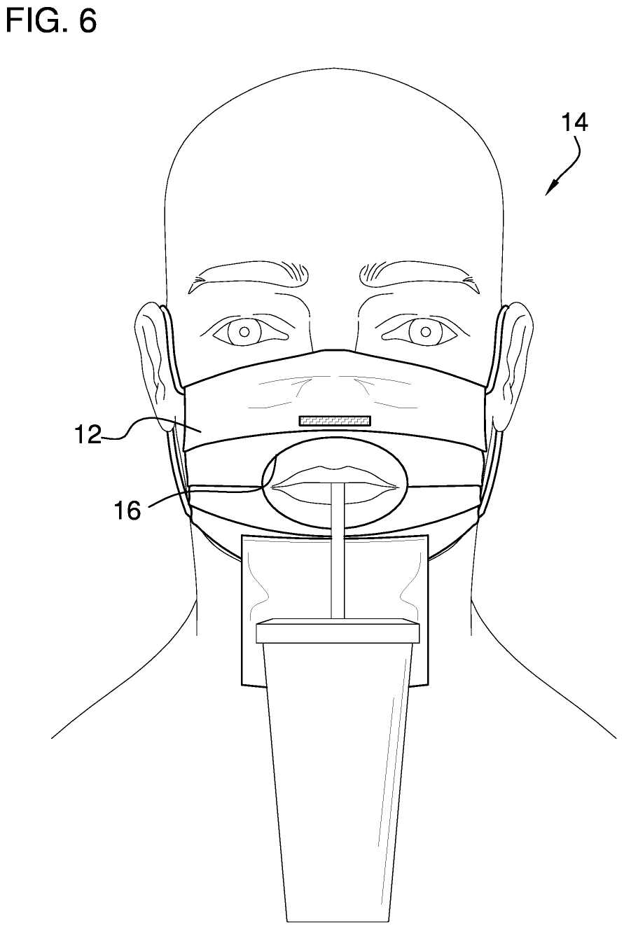

The mouth opening 16 extends through the front surface 18 and the back surface 20, and the mouth opening 16 is centrally positioned on the face mask 12. The mouth opening 16 has a bounding edge 34, and the bounding edge 34 is continuously arcuate about a center point of the mouth opening 16 such that the mouth opening 16 has a rounded shape. The mouth opening 16 is elongated along an axis extending between the first lateral side 28 and the second lateral side 30 of the perimeter edge 22 of the face mask 12 such that the mouth opening 16 has an ovoid shape. In this way, as is most clearly shown in FIG. 6, the mouth opening 16 fully exposes the user's mouth 14.

A pair of straps 35 is each coupled to the face mask 12 and each of the straps 35 can be positioned over a respective one of the user's ears 34 for retaining the face mask 12 on the user's face 36. Each of the straps 35 has a first end 38 and a second end 40, and each of the first end 38 and the second end 40 of each of the straps 35 is coupled to a respective one of the first lateral side 28 and the second lateral side 30 of the perimeter edge 22 of the face mask 12 such that each of the straps 35 forms a closed loop. Additionally, each of the straps 35 is comprised of an elastomeric material to accommodate various sizes of users.

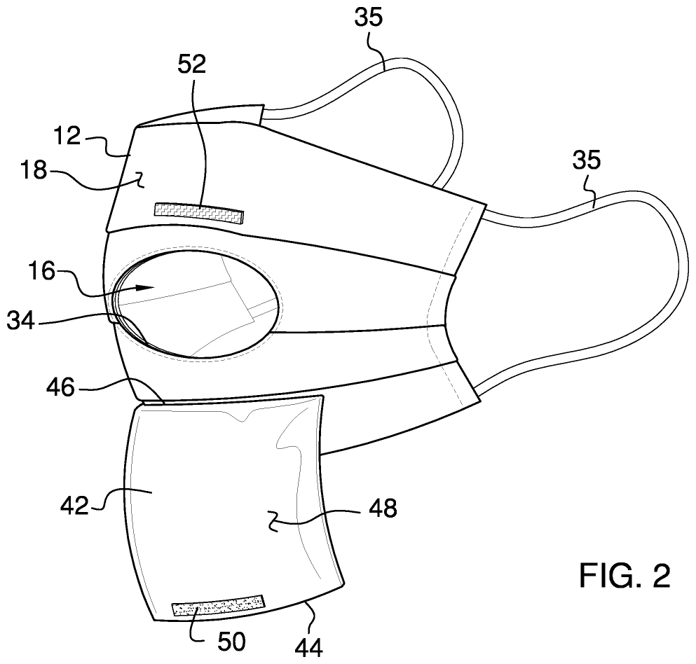

A flap 42 is movably coupled to the face mask 12 and the flap 42 is comprised of a particulate filtering material. The flap 42 is positionable in a closed position having the flap 42 covering the mouth opening 16 such that the flap 42 filters air breathed by the user 14. The flap 42 is positionable in an open position having the flap 42 exposing the mouth opening 16 to facilitate the user 14 to eat or drink. The flap 42 has a top edge 44, a bottom edge 46 and a rear surface 48, and the bottom edge 46 is coupled to the front surface 18 of the face mask 12 at a point that is positioned beneath the mouth opening 16. The rear surface 48 of the flap 42 rests against the front surface 18 of the face mask 12 when the flap 42 is positioned in the closed position. Additionally, the rear surface 48 of the flap 42 is displaced from the front surface 18 of the face mask 12 when the flap 42 is positioned in the open position. As is most clearly shown in FIGS. 2 and 6, the flap 42 extends downwardly on the face mask 12 when the flap 42 is in the open position.

A first mating member 50 is provided and the first mating member 50 is coupled to flap 42. The first mating member 50 is positioned on the rear surface 48 of the flap 42, and the first mating member 50 is positioned adjacent to the top edge 44 of the flap 42. A second mating member 52 is coupled to the face mask 12 and the first mating member 50 is releasably mated to the first mating member 50 when the flap 42 is in the closed position. In this way the flap 42 can be retained in the closed position. The second mating member 52 is positioned on the front surface 18 of the face mask 12 and the second mating member 52 is positioned between the mouth opening 16 and the top side 24 of the perimeter edge 22 of the face mask 12. Each of the first mating member 50 and the second mating member 52 may comprise complementary portions of a hook and loop fastener or other type of releasable, multiple use fastener.

In use, the face mask 12 is worn to comply with the Center for Disease Control guidelines for the reduction of transmission of airborne infectious diseases. The flap 42 is positioned in the closed position to facilitate the normal function of the face mask 12. The flap 42 is positioned in the open position to facilitate the user 14 to eat or drink while the user 14 is wearing the face mask 12. In this way the user 14 can enjoy dining in a restaurant, for example, while still wearing the face mask 12 in order to fully comply with mask mandates that might be in place during the Covid pandemic.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A face mask assembly having a mouth opening and a detachable flap thereby facilitating a user to eat and drink, said assembly comprising:
a face mask being comprised of a particulate filtering material wherein said face mask is configured to filter air being breathed by a user when the user is wearing said face mask, said face mask having a mouth opening extending through said face mask wherein said mouth opening is configured to expose the user's mouth when said face mask is worn to facilitate eating and drinking;
a pair of straps, each of said straps being coupled to said face mask wherein each of said straps is configured to be positioned over a respective one of the user's ears for retaining said face mask on the user's face;
a flap being movably coupled to said face mask, said flap being comprised of a particulate filtering material, said flap being positionable in a closed position having said flap covering said mouth opening wherein said flap is configured to filter air breathed by the user, said flap being positionable in an open position having said flap exposing said mouth opening wherein said flap is configured to facilitate the user to eat or drink;
a first mating member being coupled to flap; and
a second mating member being coupled to said face mask, said first mating member being releasably mated to said first mating member when said flap is in said closed position for retaining said flap in said closed position.

2. The assembly according to claim 1, wherein:
said face mask has a front surface, a back surface and a perimeter edge extending between said front surface and said back surface, said perimeter edge having a top side, a bottom side, a first lateral side and a second lateral side;
said face mask has a plurality of pleats being integrated into said face mask, each of said pleats extending between said first lateral side and said second lateral side, said pleats being spaced apart from each other and being distributed between said top side and said bottom side such that said face mask has an adjustable height wherein said face mask is configured to accommodate a variety of sizes of users; and
said mouth opening extends through said front surface and said back surface, said mouth opening being centrally positioned on said face mask, said mouth opening having a bounding edge, said bounding edge being continuously arcuate about a center point of said mouth opening such that said mouth opening has a rounded shape, said mouth opening being elongated along an axis extending between said first lateral side and said second lateral side of said perimeter edge of said face mask such that said mouth opening has an ovoid shape.

3. The assembly according to claim 2, wherein said flap has a top edge, a bottom edge and a rear surface, said bottom edge being coupled to said front surface of said face mask at a point being positioned beneath said mouth opening, said rear surface of said flap resting against said front surface of said face mask when said flap is positioned in said closed position, said rear surface of said flap being displaced from said front surface of said face mask when said flap is positioned in said open position.

4. The assembly according to claim 1, wherein:
said face mask has a front surface, a back surface and a perimeter edge extending between said front surface and said back surface, said perimeter edge having a top side, a bottom side, a first lateral side and a second lateral side;
said flap has a top edge and a rear surface;
said first mating member is positioned on said rear surface of said flap, said first mating member is positioned adjacent to said top edge of said flap; and
said second mating member is positioned on said front surface of said face mask, said second mating member being positioned between said mouth opening and said top side of said perimeter edge of said face mask.

5. A face mask assembly having a mouth opening and a detachable flap thereby facilitating a user to eat and drink, said assembly comprising:
a face mask being comprised of a particulate filtering material wherein said face mask is configured to filter air being breathed by a user when the user is wearing said face mask, said face mask having a mouth opening extending through said face mask wherein said mouth opening is configured to expose the user's mouth when said face mask is worn to facilitate eating and drinking, said face mask having a front surface, a back surface and a perimeter edge extending between said front surface and said back surface, said perimeter edge having a top side, a bottom side, a first lateral side and a second lateral side, said face mask having a plurality of pleats being integrated into said face mask, each of said pleats extending between said first lateral side and said second lateral side, said pleats being spaced apart from each other and being distributed between said top side and said bottom side such that said face mask has an adjustable height wherein said face mask is configured to accommodate a variety of sizes of users, said mouth opening extending through said front surface and said back surface, said mouth opening being centrally positioned on said face mask, said mouth opening having a bounding edge, said bounding edge being continuously arcuate about a center point of said mouth opening such that said mouth opening has a rounded shape, said mouth opening being elongated along an axis extending between said first lateral side and said second lateral side of said perimeter edge of said face mask such that said mouth opening has an ovoid shape;
a pair of straps, each of said straps being coupled to said face mask wherein each of said straps is configured to be positioned over a respective one of the user's ears for retaining said face mask on the user's face, each of said straps having a first end and a second end, each of said first end and said second end of each of said straps being coupled to a respective one of said first lateral side and said second lateral side of said perimeter edge of said face mask such that each of said straps forms a closed loop, each of said straps being comprised of an elastomeric material wherein each of said straps is configured to accommodate various sizes of users;
a flap being movably coupled to said face mask, said flap being comprised of a particulate filtering material, said flap being positionable in a closed position having said flap covering said mouth opening wherein said flap is configured to filter air breathed by the user, said flap being positionable in an open position having said flap exposing said mouth opening wherein said flap is configured to facilitate the user to eat or drink, said flap having a top edge, a bottom edge and a rear surface, said bottom edge being coupled to said front surface of said face mask at a point being positioned beneath said mouth opening, said rear surface of said flap resting against said front surface of said face mask when said flap is positioned in said closed position, said rear surface of said flap being displaced from said front surface of said face mask when said flap is positioned in said open position;
a first mating member being coupled to flap, said first mating member being positioned on said rear surface of said flap, said first mating member being positioned adjacent to said top edge of said flap; and
a second mating member being coupled to said face mask, said first mating member being releasably mated to said first mating member when said flap is in said closed position for retaining said flap in said closed position, said second mating member being positioned on said front surface of said face mask, said second mating member being positioned between said mouth opening and said top side of said perimeter edge of said face mask.
